(19) United States
(12) Patent Application Publication
(10) Pub. No.: US 2026/0063436 A1
(43) Pub. Date: Mar. 5, 2026

(54) HYBRID-ELECTRIC VEHICLE NAVIGATION

(71) Applicant: INTERNATIONAL BUSINESS MACHINES CORPORATION, ARMONK, NY (US)

(72) Inventors: YU ZHU, Beijing (CN); PENG HUI JIANG, Beijing (CN); JUN SU, Beijing (CN); GUANG HAN SUI, Beijing (CN); SU LIU, Austin, TX (US); JUN FENG DUAN, Beijing (CN)

(21) Appl. No.: 18/824,962

(22) Filed: Sep. 5, 2024

(51) Int. Cl. G01C 21/34

(52) U.S. Cl. CPC G01C 21/3469; G01C 21/3476; G01C 21/3492

(57) ABSTRACT

Automatic provision by a computing device of navigation for a hybrid-electric vehicle to best take advantage of dual-powering capabilities of the hybrid-electric vehicle. A computing device receives a destination for a hybrid-electric vehicle to navigate the hybrid-electric vehicle to. The computing device accesses a current location of the hybrid-electric vehicle. The computing device accesses current and historical vehicle data for the hybrid-electric vehicle. The computing device accesses current and historical traffic data for the hybrid-electric vehicle. The computing device accesses driver data. The computing device accesses point-of-interest data for the current location in which the hybrid-electric is located. The computing device generates automatically one or more driving routes for the hybrid-electric vehicle based upon the destination, current location, current and historical vehicle data, current and historical traffic data, driver data, and point-of-interest data.

### FIELD OF THE INVENTION

The present invention relates generally to hybrid-electric vehicles and more particularly to automated navigation of hybrid-electric vehicles.

### BACKGROUND

Presently disclosed embodiments relate to automated navigation of a hybrid-electric vehicle. Hybrid-electric vehicles present unique challenges in navigation, since they possess characteristics of both electric and gasoline vehicles. While hybrid-electric vehicles are capable of running on a combination of electricity (via a battery) and gasoline/diesel (stored onboard), each source of energy for driving the hybrid-electric vehicle presents different advantages and disadvantages.

Utilization of the electric motor primarily when the hybrid-electric is driven maximizes efficiency by utilizing little or no gasoline during a trip, presents environmental advantages, and may lead to a more pleasing ride for passengers in the hybrid-electric vehicle. Regulations present in certain areas may also require utilization of an electric motor in, for example, a city center. Unfortunately, batteries available for hybrid-electric vehicles at present only allow several hundred miles of travel before the battery needs to be charged, and charging with a traditional 110 volt AC electrical socket may be very slow (taking multiple hours or even days). Fast charging stations may be available in some areas which negate this drawback, but availability of fast charging may be more limited in some rural or suburban areas. Without the benefit of a fast charger, charging may take much longer than simply refueling the fuel tank of the hybrid-electric vehicle. This makes trips in areas where fast charging is not available take a prohibitive amount of time or be entirely impossible.

Utilization of the gasoline motor primarily when driving a hybrid-electric vehicle, on the other hand (despite the drawbacks associated with gasoline motor), maximizes range for the vehicle and greatly facilitates refueling the hybrid-electric vehicle to, for example, drive through a desert where charging options may be limited. Electric charging stations to provide faster charging for the hybrid-electric vehicle are even more rare or non-existent in these areas, and gasoline may provide a more practical solution for this type of trip.

It therefore may be beneficial to utilize routes which maximize the benefits of hybrid-electric vehicles, while minimizing the drawbacks. In many situations, alternate routes can be planned which provide different facilities for charging/refueling, etc. or provide other advantages. Automated navigation systems at present may offer automated route planning guidance, but are not suited to confront unique issues associated with hybrid-electric vehicles, as well as maximize their benefits. In order to best realize the benefits of a hybrid-electric vehicle, therefore, a need presents itself for an automated navigation system to take best advantage of the unique dual-powering characteristics of the hybrid-electric vehicle in real-world driving situations.

### SUMMARY

Embodiments of the present invention disclose a method, system, and computer program product to automatically provide navigation for a hybrid-electric vehicle to best take advantage of dual-powering capabilities of the hybrid-electric vehicle. A computing device receives a destination for a hybrid-electric vehicle to navigate the hybrid-electric vehicle to. The computing device accesses a current location of the hybrid-electric vehicle. The computing device accesses current and historical vehicle data for the hybrid-electric vehicle. The computing device accesses current and historical traffic data for the hybrid-electric vehicle. The computing device accesses driver data. The computing device accesses point-of-interest data for the current location in which the hybrid-electric is located. The computing device generates automatically one or more driving routes for the hybrid-electric vehicle based upon the destination, current location, current and historical vehicle data, current and historical traffic data, driver data, and point-of-interest data.

In further embodiments of the present invention, a method, system, and computer program product are disclosed in which the computing device accesses route preferences of a driver of the hybrid-electric vehicle, and calculating by the computing device one or more routes for the hybrid-electric vehicle further comprises generating two or driving routes based also at least in-part on the one or more route preferences.

In still further embodiments of the present invention, a method, system and computer program product are disclosed in which when a driver of the hybrid-electric vehicle selects a preferred route of the generated one or two or more driving routes the computing device requests an engine scheduler for the hybrid-electric vehicle associated with the preferred route.

### BRIEF DESCRIPTION OF THE DRAWINGS

FIG. 1 represents a networked computer environment 100, in accordance with an embodiment of the present invention.

FIG. 2 is a functional block diagram 200 illustrating modules for hybrid-electric vehicle navigation 200, in accordance with an embodiment of the present invention.

FIG. 3 is a sample display 300 of two driving routes for hybrid-electric vehicle 210 including display of engine usage strategy for each driving route, in accordance with an embodiment of the present invention.

FIG. 4 is a process flow diagram 400 illustrating operational steps that a hardware component, multiple hardware components, and/or a hardware appliance may execute, in accordance with an embodiment of the present invention.

### DETAILED DESCRIPTION

The presently disclosed embodiments relate one or more methods, systems, and computer program products to utilize computing devices to automatically provide navigation for a hybrid-electric vehicle. Hybrid-electric vehicles with their combination of both electrical power and gasoline power (or, alternatively, power by diesel, natural gas, hydrogen, or other combustible, collectively referred to merely as “gasoline” herein) present unique advantages over both their purely gasoline powered and purely electric powered cousins. The advantages of hybrid-electric vehicles include advantages of electric vehicles such as reduced use of fossil fuels, cost efficiency, efficiency, flexibility, silent operation, etc., as well as advantages of gasoline vehicles, including easy refueling, increased range, and others. In order to maximize benefits and minimize drawbacks, presently disclosed embodiments provide for automated navigation functions to navigate hybrid-electric vehicles in a manner which best takes advantage of the special abilities of the hybrid-electric vehicle. In navigating hybrid-electric vehicles various embodiments of the invention minimize use of the gasoline motor and maximize the use of the electric motor while driving the route suggested by the automated navigation function, while arriving at a destination in a safe and timely fashion. In various embodiments of the invention traffic patterns, driver data, point-of-interest data, route preferences, and other data points may be further utilized to personalize driving routes, as discussed herein. In various embodiments of the invention, mapping generated by the automated navigation functions can be displayed to the user via a display built into the hybrid-electric vehicle for driver information purposes, selection, or manipulation. In further embodiments of the invention, automated navigation functions may even be utilized by an on-board self-driving car system to automatically drive the car to a destination along a route suggested by the user.

According to an aspect of the invention, there is provided a computer-implemented method, system, and computer program product to automatically provide navigation for a hybrid-electric vehicle to best take advantage of the dual-powering capabilities of the hybrid-electric vehicle. In accordance with the aspect of the invention, the computer-implemented method, system, and computer program product includes receiving a destination for a hybrid-electric vehicle to navigate the hybrid-electric vehicle to, accessing a current location of the hybrid-electric vehicle, accessing current and historical vehicle data for the hybrid-electric vehicle, accessing current and historical traffic data for the hybrid-electric vehicle, accessing by the computing device driver data, accessing by the computing device point-of-interest data for the current location in which the hybrid-electric vehicle is located, and generating automatically one or more driving routes for the hybrid-electric vehicle based upon the destination, current location, current and historical vehicle data, current and historical traffic data, driver data, and point-of-interest data. A general technical advantage of these embodiments is to provide customized guidance for hybrid-electric vehicles which maximize efficiency of the hybrid-electric vehicle (using, for example, less gasoline/diesel, if possible), while still providing the driver of the hybrid-electric vehicle navigation time savings, and safe navigation to a destination.

According to another aspect of the invention, there is provided a computer-implemented method, system, and computer program product to access route preferences of a driver of the hybrid-electric vehicle and calculate two or more driving routes for the hybrid-electric vehicle based at least in-part on the one or more route preferences. A general technical advantage of these embodiments is to not only automatically provide routes which maximize efficiency of the hybrid-electric vehicle but also provide routes associated with the user's preferences (for example, a scenic but slightly longer route versus a heavily trafficked route).

According to another aspect of the invention, there is provided a computer-implemented method, system, and computer program product to request the hybrid-electric vehicle display the two or more driving routes to the driver of the hybrid-electric vehicle for selection by the driver. A general technical advantage of these embodiments of the invention is for the driver of the hybrid-electric vehicle to visualize the possible routes (as well as characteristics associated with them), for the driver to make an informed decision of which one to take.

According to another aspect of the invention, there is provided a computer-implemented method, system and computer program product wherein when a driver of the hybrid-electric vehicle selects a preferred route of the two or more generated driving routes an engine scheduler for the hybrid-electric vehicle associated with the preferred route is also requested. A general technical advantage of these embodiments of the invention is to fully maximize efficiency of the hybrid-electric vehicle by allowing the engine-scheduler to best take advantage of the electric motor during certain portions of the route based upon, for example, a close location of the next charging station.

According to another aspect of the invention, there is provided a computer-implemented method, system, and computer program product wherein the route preferences include one or more of time optimization, cost optimization, and distance optimization. A general technical advantage of these embodiments is to maximize customizability of the automatically generated routes based upon different optimization desires.

According to another aspect of the invention, there is provided a computer-implemented method, system, and computer program product where the display of the two or more driving routes also includes display of an engine usage strategy for the hybrid-electric vehicle for each of the two or more driving routes. A general technical advantage of these embodiments is to allow a driver to make an informed decision about which driving route to take based upon the displayed engine usage strategy if, for example, the driver wants to take an especially eco-friendly route even if it takes slightly longer with more miles.

According to another aspect of invention, there is provided a computer-implemented method, system, and computer program product where current and historical vehicle data includes one or more of vehicle speed, battery consumption rate, fuel tank capacity, battery capacity, and battery charging time. A general technical advantage of these embodiments is to allow specific data points of current and historical vehicle data to be utilized in best planning routes for the hybrid-electric vehicle.

According to another aspect of the invention, there is provided a computer-implemented method, system, and computer program product where current and historical traffic data includes one or more of road conditions, traffic statutes, regulation areas, and weather information. A general technical advantage of these embodiments is to allow specific data points of current and historical traffic data to plan the quickest and most efficient route for the hybrid-electric vehicle.

According to another aspect of the invention, there is provided a computer-implemented method, system, and computer program product where driver data includes driver behavior data, special driver requirements, and noise level. A general technical advantage of these embodiments is to allow specific data points regarding driver behavior to be used in planning driver routes for the hybrid-electric vehicle which best take advantage of driver data in providing route guidance for the hybrid-electric vehicle.

According to another aspect of the invention, there is provided a computer-implemented method, system, and computer program product where point-of-interest data includes gasoline station location data, charging station location data, charging station type information, fuel price, charging price, charging station power information, and charging station interface information. A general technical advantage of these embodiments is to allow specific data points regarding point-of-interest data to plan routes for hybrid-electric vehicle which best take advantage of point-of-interest data in planning routes in order to, for example, use point-of-interest data on gasoline station location data and charging station location data in planning the most efficient driving route.

According to another aspect of the invention, there is provided a computer-implemented method, system, and computer program product to collect real-time information, and use the real-time information to determine whether to update the one or more driving routes and, if a determination is made that the one or more driving routes need to be updated, updating the one or more driving routes. A general technical advantage of these embodiments is to provide route guidance for the hybrid-electric vehicle which provides the best guidance in real-time, as changes may happen because of car accidents, new construction projects, potholes, etc.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as associated with modules for hybrid-electric vehicle navigation 200. In addition to modules 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and modules 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

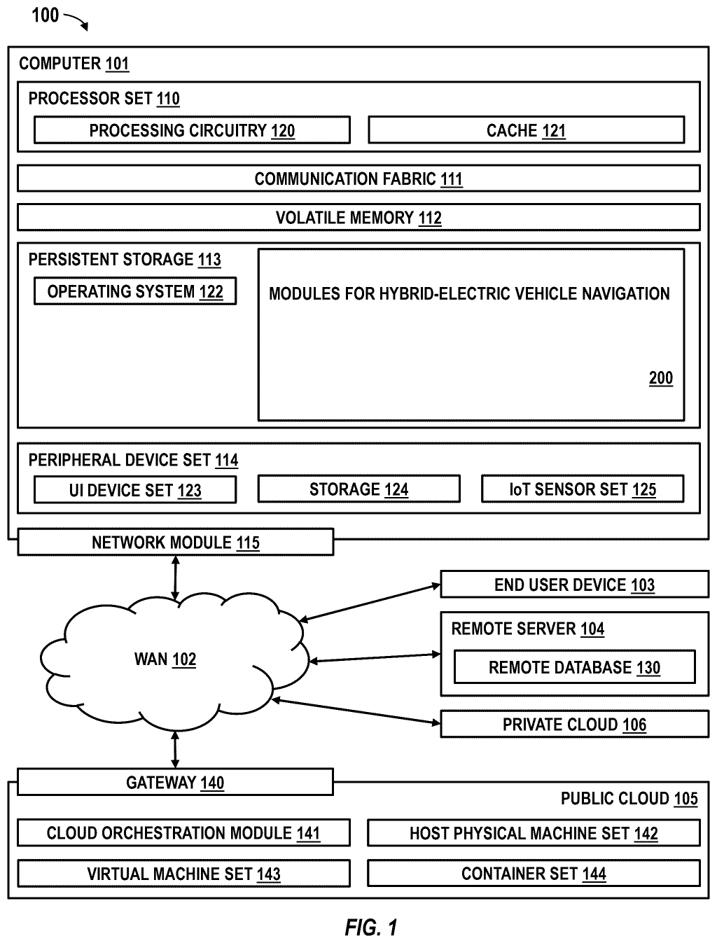

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processor set 110 may be alternatively be referred to herein as one or more “computing device(s),” but computing devices may also refer to one or more CPUs, microchips, integrated circuits, embedded systems, or the equivalent, presently existing or after-arising. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in modules 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in modules 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

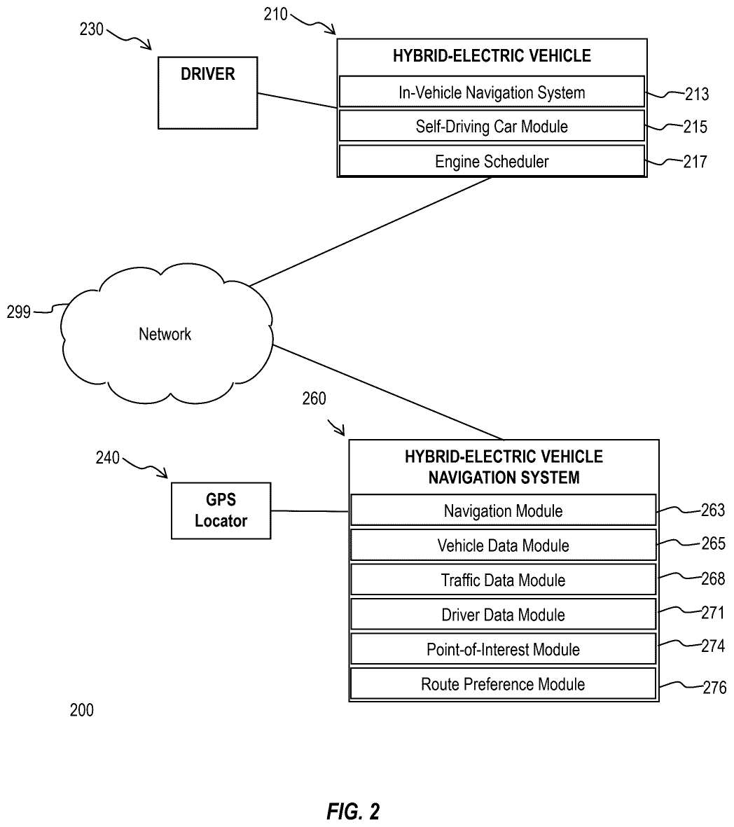

FIG. 2 is a functional block diagram 200 illustrating modules hybrid-electric vehicle navigation 200, in accordance with an embodiment of the present invention. As an overview, FIG. 2 displays hybrid-electric vehicle 210 and hybrid-electric vehicle navigation system 260, as well as network 299. In an embodiment of the invention, hybrid-electric vehicle 210 is operatively connected to hybrid-electric vehicle navigation system 260 directly or via network 299. In an embodiment of the invention, hybrid-electric vehicle navigation system 260 is integrated with hybrid-electric vehicle 210. Hybrid-electric vehicle 210 may be any sort of hybrid-electric vehicle 210 with dual-powering capability (i.e. capable of using gasoline to power an internal-combustion engine, as well as use electricity as a power source to power one or more electric motors). Hybrid-electric vehicles 210, as used herein, may include cars, trucks, buses, motorcycles, etc. Hybrid-electric vehicle navigation system 260 represents software and/or hardware for planning of routes for hybrid-electric vehicle 210 which best take advantage of the dual-powering capabilities of the hybrid-electric vehicle 210, considering the preferences of driver 230, the capabilities of hybrid-electric vehicle 210, and other data points or preferences, (as discussed further herein). Generally, in an embodiment of the invention, in order to generate route guidance for hybrid-electric vehicle 210, after receiving from driver 230 a destination for guiding the hybrid-electric vehicle to, hybrid-vehicle navigation system 260 determines the present location of hybrid-electric vehicle 210 (such as by utilization of GPS locator 240, cell-phone town triangulation, or other equivalent means) and automatically generates navigation routes for the hybrid-electric vehicle 210 which most efficiently utilize the electric motor and the gas motor to navigate to a destination selected by driver 230 based upon one or more of available maps, vehicle data, points-of-interest, traffic data, as well as additionally or alternatively other data points (as discussed further herein). Hybrid-electric vehicle navigation system 260, after generating one or more routes, displays the generated routes to the driver 230 via a display in hybrid-electric vehicle 210 for information purposes, selection by driver 210, or even for communication to a self-driving guidance system associated with hybrid-electric vehicle 210 to automatically drive the hybrid-electric vehicle 210 along the selected route. In various embodiments of the invention, hybrid-electric vehicle navigation system 260 may utilize artificial intelligence or mathematical weighting schemes in automatically generating routes for hybrid-electric vehicle 210.

As further displayed in FIG. 2, in various embodiments of the invention, hybrid-electric vehicle 210 and hybrid-electric vehicle navigation system 260 are connected to and via network 299. In various embodiments of the invention, network 299 is substantially the same as WAN 120, discussed in connection with FIG. 1 herein. In general, network 299 may be any combination of connections and protocols that will support communications between hybrid-electric vehicle 210 and hybrid-electric vehicle navigation system 260, in accordance with embodiments of the invention. In further embodiments of the invention, network 299 may represent a bus associated with a single or multicore processor (or multiple processors or embedded systems) executing functionality associated with both hybrid-electric vehicle 210 and hybrid-electric vehicle navigation system 260 (such as in embodiments where hybrid-electric vehicle 210 and hybrid-electric vehicle navigation system 260 are integrated).

Discussing elements displayed in FIG. 2 in further detail, hybrid-electric vehicle 210 represents any sort of hybrid-electric vehicle 210 which would benefit from embodiments of the invention presented herein. Hybrid-electric vehicle 210 may be, in various embodiments of the invention, a car, truck, bus, motorcycle, etc. Hybrid-electric vehicle 210 includes both an electric motor powered by electricity stored onboard by a battery or capacitor, and a gasoline engine (or presently existing or after-arising equivalents) which is powered by gasoline stored onboard the hybrid-electric vehicle 210. As would be understood by one of skill in the art, the electric motor of hybrid-electric vehicle 210 presents environmental benefits, cost savings, and quiet operation. Unfortunately, batteries, super-capacitors, and other electric storage have not advanced to the point where the electric motor can be utilized for very long distances without stopping to recharge. Fast charging, solar charging, and other options may mitigate some of these drawbacks to the electric motor, but these may not be available along certain routes or certain areas. In such circumstances, it is necessary to rely upon the gasoline engine in order for hybrid-electric vehicle 210 to reach its destination. The gasoline engine presents the advantage of easy and fast refueling in order to facilitate long distance operation (with gasoline widely available globally, even in rural areas, and re-fueling of hybrid-electric vehicle 210 with gasoline taking mere minutes). This engine can also be used to recharge batteries of hybrid-electric vehicle 210, if required. Hybrid-electric vehicle navigation system 260 may be utilized, in various embodiments of the invention, to mitigate some of the drawbacks of the electric motor, however, while still allowing driver 230 to arrive at a destination in a timely and safe fashion. In various embodiments of the invention, hybrid-electric vehicle 210 includes one or more of in-vehicle navigation system 213, (optionally) self-driving car module 215, and engine scheduler 217.

In-vehicle navigation system 213 represents software and/or hardware for displaying navigation routes generated by hybrid-electric vehicle navigation system 260 to driver 230 via an in-dash navigation system (or the equivalent) which is configured to display a map of the area where hybrid-electric vehicle 210 is located, as well as one or more driving routes the driver 230 may select. In various embodiments of the invention, in-vehicle navigation system 213 may have a touch screen (or the equivalent) which allows driver 230 to interact with and select various driving routes.

Self-driving car module 215 represents software and/or hardware for automatic driving of hybrid-electric vehicle 215 (when present in hybrid-electric vehicle 210). Self-driving car module 215 utilizes data from various sensors, cameras, to use artificial intelligence software to automatically steer, accelerate, and brake hybrid-electric vehicle 210 to an intended destination while avoiding other vehicles, road traffic, etc. In an embodiment of the invention, routes generated by hybrid-electric vehicle navigation system 260 are automatically driven by hybrid-electric vehicle 210 utilizing self-driving car module 215, after a route is selected by driver 230 from in-vehicle navigation system 213. In an embodiment of the invention, engine scheduler 217 (discussed below) further confirms the routes driven utilize the electric motor of hybrid-electric vehicle 210 as much as possible (in order to maximize gasoline savings and efficiency).

Engine scheduler 217 represents software and/or associated hardware for scheduling of utilization of electric and gas engines of hybrid-electric vehicle 210 during driving of a planned driving route. In embodiments the invention, in order to maximize efficiency of hybrid-electric vehicle 210, engine scheduler 217 schedules utilization of electric motor of hybrid-electric vehicle 210 along segments of driving routes where utilization of the electric motor is possible in order to maximize efficiency of the hybrid-electric vehicle 210. Engine scheduler 217, for example, may maximize utilization of the electric motor of hybrid-electric vehicle 210 along a segment of a route where fast chargers are common (allowing charging of hybrid-electric vehicle 210 in under 20 minutes). On the other hand, along segments of routes where fast charging is not available, in order to keep travel time of hybrid-electric vehicle 210 to a reasonable limit, engine scheduler 217 schedules utilization of the gas motor to both travel, and re-charge hybrid-electric vehicle 210 while driving these segments. In various embodiments of the invention, engine scheduler 217 is supported by a trained neural network or other artificial intelligence model which is trained on data from previously driven routes driven by hybrid-electric vehicle 210 or other vehicles (including, for example, as training data, data on the amount of gasoline utilized by gasoline engine of hybrid-electric vehicle, amount of electricity utilized by electric motor of hybrid-electric vehicle 210, travel time, time in traffic, etc.), in order to obtain the best efficiency for hybrid-electric vehicle 210. In further embodiments of the invention, a base artificial intelligence model is used which is re-trained for use with the particular hybrid-electric vehicle 210, (retrained based upon localized map information, particularities of the hybrid-electric vehicle 210 (such as miles per gallon of fuel, and battery range), etc.). The base artificial intelligence model with the thusly re-trained base artificial intelligence model is then utilized by engine scheduler 217 in order to obtain maximum efficiency from hybrid-electric vehicle 210. The trained neural network/re-trained artificial intelligence model/other artificial intelligence model associated with engine scheduler 217, as one of skill in the art would understand, in various embodiments of the invention obtains the best efficiency results, generally, by scheduling of the utilization of the electric motor as well as the gas motor during the most advantageous times during driving.

Continuing to discuss elements of FIG. 2 in further detail, hybrid-electric vehicle navigation system 260 represents software and/or hardware to automatically provide navigation for hybrid-electric vehicle 210. In an embodiment of the invention, navigation for hybrid-electric vehicle 210 takes the form of one or more driving routes for hybrid-electric vehicle 210 which are displayed to driver 230 for selection via an in-dash navigation system associated with hybrid-electric vehicle 210, or otherwise. The one or more driving routes generated by hybrid-electric vehicle navigation system 260 take best advantage of the dual-powering capabilities of hybrid-electric vehicle 210, as further discussed herein, in order to maximize efficiency (i.e. use a minimal amount of gasoline/diesel) while still arriving at a destination in a timely fashion. In various embodiments of the invention, hybrid-electric vehicle navigation system 260 includes one or more of navigation module 263, vehicle data module 265, traffic data module 268, driver data module 271, point-of-interest module 274, and route preference module 276. Data made available from one or more of navigation module 263, vehicle data module 265, traffic data module 268, driver data module 271, point-of-interest module 274, and route preference module 276 may be utilized in embodiments of the invention to generate driving routes for hybrid-electric vehicle 210, as is further discussed herein.

Navigation module 263 represents software and/or hardware for generation of driving routes for hybrid-electric vehicle 210. Navigation module 263 receives a destination to navigate hybrid-electric vehicle 210 to. The destination may be entered by a driver 230 of hybrid-electric vehicle 210 using an in-dash navigation system, stored by hybrid-electric vehicle 210 for entering according to a pre-determined schedule, or entered otherwise. In beginning guidance, navigation module 263 first accesses the current location of hybrid-electric vehicle 210. The current location of hybrid-electric vehicle 210 may be accessed via a GPS locator 240 (associated with hybrid-electric vehicle 210 or otherwise), via cell-phone triangulation, or any other means. In various embodiments of the invention, navigation module 263 after receiving destination to navigate hybrid-electric vehicle 210, generates one or more driving routes for hybrid-electric vehicle 210 which maximize efficiency of hybrid-electric vehicle 210 (i.e., uses the electric motor of hybrid-electric vehicle 210 as much as possible). In various embodiments of the invention, the routes generated by hybrid-electric vehicle 210, rely upon one or more of destination (entered by driver 230, or in another way), current location (obtained by gps locator 240), current and historical vehicle data (from vehicle data module 265), current and historical traffic data (from traffic data module 268), driver data (from driver data module 271), point-of-interest data (from point-of-interest module 274), and route preferences (from route preference module 276). In various embodiments of the invention, data available from any of the previously mentioned modules is used in different ways, such as according to a weighting formula (weighting each available data point), or according to another scheme, in order to best generate efficient routes for hybrid-electric vehicle 210 (while adhering to route preferences associated with driver 230, etc.). In an embodiment of the invention, navigation module 263 utilizes a trained neural network or other sort of equivalent artificial intelligence model (trained upon previous routes driven by hybrid-electric vehicle 210, and/or other vehicles), in order to most effectively utilize any or all data points provided in order to provide the best navigation routes for hybrid-electric vehicle 263. User feedback received from driver 230 in real-time or otherwise may be further utilized to improve routes generated by navigation module 263 utilizing neural network/other artificial intelligence.

Vehicle data module 265 represents software and/or hardware for tracking and storage of current and/or historical vehicle data associated with hybrid-electric vehicle 210. Vehicle data is utilized in various embodiments of the invention in generating driving routes for the hybrid-electric vehicle 210. In various embodiments of the invention, current and/or historical vehicle data includes one or more of vehicle speed, battery consumption rate, fuel tank capacity, battery capacity, and battery charging time. Any of the current and/or historical vehicle data may be utilized in calculating or present routes for the hybrid-electric vehicle 210. In various embodiments of the invention, current/historical vehicle data is used according to a formula which weights the various available current/historical vehicle data in calculating routes for the hybrid-electric vehicle 210. For example, if the battery consumption rate of the electric motor for the hybrid-electric vehicle 210 indicates that the battery will not last the entirety of a drive along a possible driving route, hybrid-electric vehicle navigation system 260 will not recommend that route if there is also insufficient gasoline in the hybrid-electric vehicle 210 to reach the next gas station. As one of skill in the art would understand, different data available in current/historical vehicle data is utilized in different calculations of possible driving routes, according to both the preferences of the driver 230 and availability of current/historical vehicle data.

Traffic data module 268 represents software and/or hardware for obtaining of real-time and/or historical traffic data along various routes for utilization in calculations by hybrid-vehicle navigation system 260 of new driving routes for hybrid-electric vehicle 210 which best take advantage of the capabilities of hybrid-electric vehicle 210. Traffic data is of special importance to hybrid-electric vehicle 210, because in planning possible driving routes which maximize efficiency of the hybrid-electric vehicle 210, traffic may become a critical concern when attempting to avoid utilization of the gasoline engine. For example, a shorter route which is frequently subject to high traffic at rush hour may make it impossible to utilize the electric motor for hybrid-electric vehicle 210 for the entire duration of the car ride. In circumstances such as this, a longer route would be more efficient if the hybrid-electric vehicle 210 was to utilize the route during rush hour. As another example, a car accident occurring in real-time may make cause traffic issues along a certain route, and make it necessary for re-routing of hybrid-electric vehicle 210, in order to best maintain efficiency of hybrid-electric vehicle 210 (and avoid utilization of the gasoline engine as much as possible). In various embodiments of the invention, current/historical traffic data may include one or more of delay along route, road conditions, traffic statutes, regulation areas, speed zone camera location notifications, and weather information. Any or all of these may be utilized by hybrid-electric vehicle navigation system 260 in generation of routes which take advantage of the capabilities of hybrid-electric vehicle 210. At present (or in the foreseeable future), regulation areas may demand use of electric motors in certain urban areas or areas with particularly sensitive environmental requirements, and traffic data module 268 may be utilized to take account of these as well.

Driver data module 268 represents hardware and/or software for obtaining and/or storing various data associated with the driver 230 of hybrid-electric vehicle 210. When planning driving routes which hybrid-electric vehicle 210 utilizes to best take advantage of the dual-powering capabilities of hybrid-electric vehicle 210, driver data may be utilized according to a weighting scheme, with the driver data overriding a possible route based upon preferences included in driver data, or otherwise. In various embodiments of the invention, driver data obtained and/or stored by driver data module 268 may include one or more of driver behavior data, special driver requirements, and noise level requirements. Driver behavior data may include, for example, a preference for less trafficked routes or scenic routes, even if these take a longer period of time to drive by hybrid-electric vehicle 210. Special driver requirements may include, for example an absolute preference for only utilization of the electric motor of hybrid-electric vehicle 210, even if long charging breaks need to be taken. Noise level requirements may include both internal or external noise, with some drivers not desiring to have excessive amounts of external noise, or some drivers preferring to use the electric motor of hybrid-electric vehicle 210 more extensively to keep the ride of hybrid-electric vehicle 210 as quiet as possible.

Point-of-interest module 271 represents software and/or hardware for accessing and/or storing data related to various points-of-interest in the geographic area where hybrid-electric vehicle 210 is located. Data regarding points-of-interest may be utilized in various embodiments of the invention in calculating routes for hybrid-electric vehicle 210. A certain route may not be utilized because, for example, a lack of electrical charging stations along the route would increase the amount of gasoline used by hybrid-electric vehicle 210. Points-of-interest accessed and/or stored by point-of-interest module 271 may include, in various embodiments of the invention, gasoline station location data, charging station location data, charging station type information, fuel price, charging prices, charging station information, and charging station interface information. In various embodiments of the invention, in planning routes for hybrid-electric vehicle 271, points-of-interest are crucial in determining the routes. If, for example, a route is being considered which will utilize the electric motor, it is necessary to find not only that there are charging stations along the route, but that the charging stations have proper connections to charge hybrid-electric vehicle 210 and that the charging station information indicates it is of a “fast” charger type which charges hybrid-electric vehicle 210 in under fifteen minutes (or, some other period of time). In alternative embodiments, if utilization of the electric motor of hybrid-electric vehicle 210 is impossible along certain routes, hybrid-electric vehicle navigation system 260 plans routes which minimize use of the gasoline motor, and use the electric motor as much as possible. Different points-of-interest stored by point-of-interest module 271 may be used in different embodiments of the invention in generation of driving routes which maximize efficiency of the hybrid-electric vehicle 210, according to a weighting scheme or otherwise, while contemplated in the scope of embodiments of the invention.

Route preference module 276 represents software and/or hardware for accessing and/or storing route preferences associated with driver 230. Route preferences in route preference module 276 are utilized in generating routes for hybrid-electric vehicle 210. In various embodiments of the invention, route preferences may include one or more of time optimization, cost optimization, and distance optimization. Driving routes accessed/stored by route preferences module 276 may be used in-part or fully in generating possible driving routes. In generating routes or selecting routes for display which best take advantage of the dual-powering capabilities of hybrid-electric vehicle 210, route preferences may be utilized by hybrid-electric vehicle navigation system 260 in generating routes according to a weighting scheme or another scheme. If driver 230 has a route preference for time optimization, hybrid-electric vehicle navigation system 260 generates one or more routes which minimize driving time, with less of an emphasis placed upon utilization of the electric motor of hybrid-electric vehicle 210. If driver 230 has a route preference for cost optimization, hybrid-electric vehicle navigation system 260 generates one or more routes which maximize cost savings by maximizing utilization of the electric motor of hybrid-electric vehicle 210 with less of an emphasis or no emphasis on time or distance of routes (even if multiple charging stops are necessary, even with a non-fast charger). If driver 230 has a route preference for distance optimization, hybrid-electric vehicle navigation system 260 calculates one or more driving routes which minimize distance, with less of an emphasis or no emphasis on cost savings or time savings. In various embodiments of the invention, a weighting scheme may be utilized by hybrid-electric vehicle navigation system placing various amounts of emphasis on route preferences. In alternative embodiments of the invention, the neural network (or other machine learning model) discussed in connection with navigation module 263 takes account of data provided by router preference model 276.

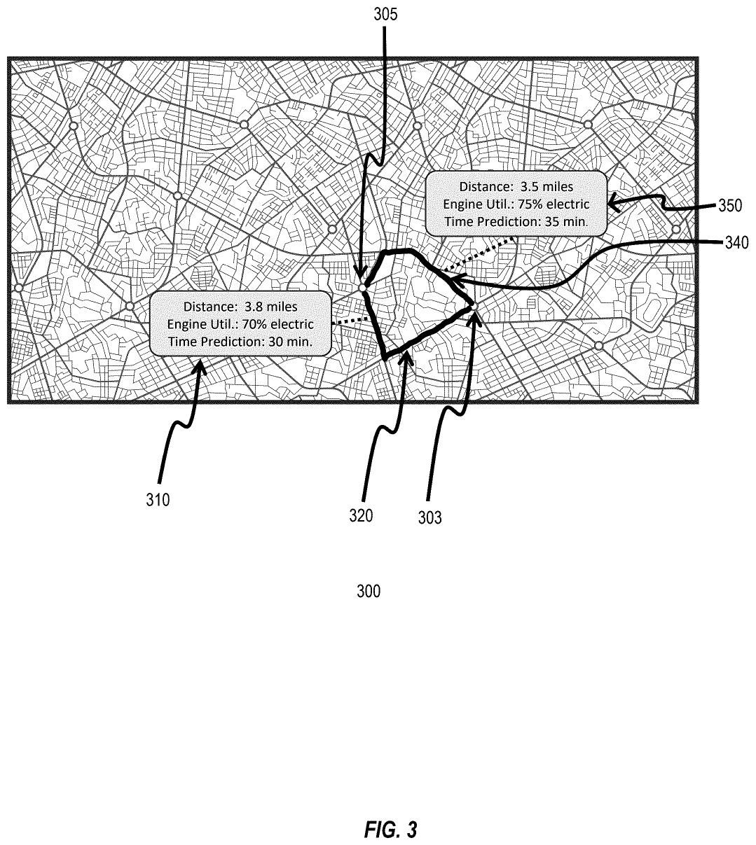

FIG. 3 is a sample display 300 of two or more driving routes 320, 340 for display to driver 230 of hybrid-electric vehicle 210. Both of driving routes 320, 340 go from origin 303 to destination 305 along different routes. Driving routes A 320 and driving route B 340 are displayed to driver 230 to allow driver to make a selection of one driving route for the hybrid-electric vehicle 210 to navigate. As is displayed in FIG. 3, also displayed in connection with each driving route 320, 340 is route information pop-up 310, 350 which indicate distance associated with each route 320, 340, an engine usage strategy (indicating a percentage of the driving route which is expected to utilize the electric motor of hybrid electric vehicle 210), as well as a time prediction for driving each route 320, 340. Driver 230 selects a driving route routes 320, 340 and driving of hybrid-electric vehicle 210 may commence along selected route. Real-time information made available from one or more of vehicle data module 265, traffic data module 268, driver data module 271, point-of-interest module 274, and route preference module 276 may cause the selected driving route 320, 340 to be updated at any time (if a determination is made by hybrid-electric vehicle navigation system 260 that an update to the selected driving route needs to be made, such as because of traffic building up unexpectedly or an electrical charging station relied upon along selected driving route suddenly going offline).

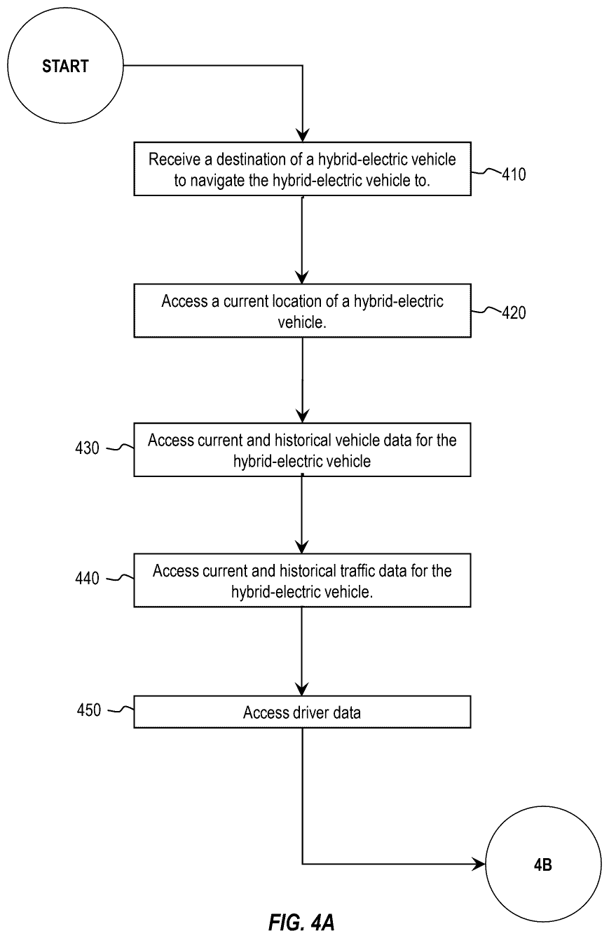

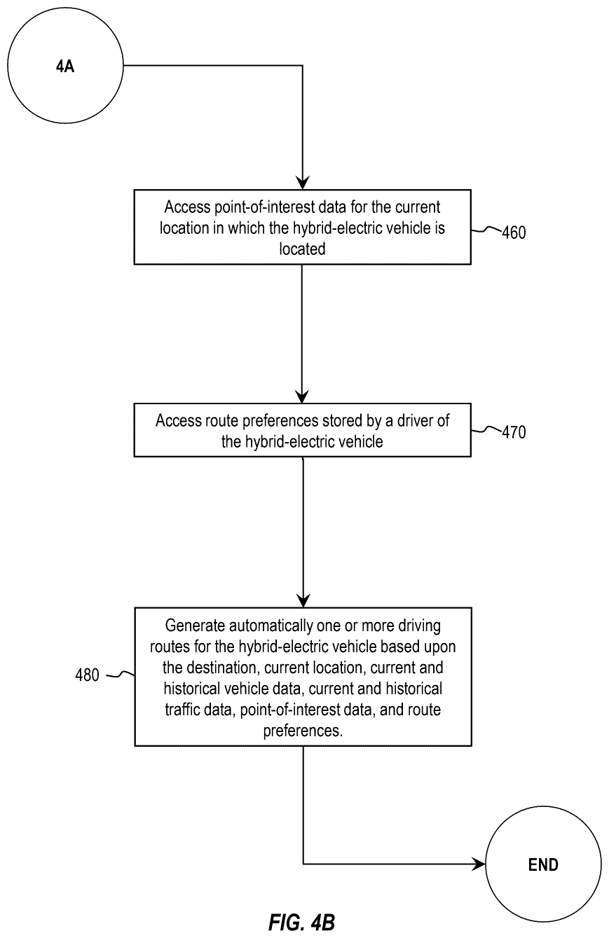

FIG. 4 is a process flow diagram 400 illustrating operational steps that a hardware component, multiple hardware components, and/or a hardware appliance may execute, in accordance with an embodiment of the present invention. As shown in FIG. 3, at step 410 a destination for hybrid-electric vehicle 210 to is received by navigation module 263. At step 420, a current location of hybrid-electric vehicle 210 is accessed by navigation module 263 via GPS locator 240. At step 430, vehicle data module 265 accesses current and historical vehicle data for the hybrid-electric vehicle 210. At step 440, traffic data module 268 accesses current and historical traffic data for the hybrid-electric vehicle 210. At step 450, driver data module 271 accesses driver data associated with driver 230. At step 460, point-of-interest module 274 accesses point-of-interest data for the current location in which the hybrid-electric vehicle 210 is located. At step 470, route preferences of driver 230 are accessed by route preference module 276. At step 480, navigation module automatically generates one or more driving routes for the hybrid-electric vehicle 210 based upon the destination, current location, current and historical vehicle data, point-of-interest data, and route preferences (and, as discussed elsewhere herein, in an embodiment of the invention are then displayed to driver 230 of hybrid-electric vehicle 210).

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method using a computing device to automatically provide navigation for a hybrid-electric vehicle to take best advantage of dual-powering capabilities of the hybrid-electric vehicle, the method comprising:
receiving by a computing device a destination for a hybrid-electric vehicle to navigate the hybrid-electric vehicle to;
accessing by a computing device a current location of the hybrid-electric vehicle;
accessing by the computing device current and historical vehicle data for the hybrid-electric vehicle;
accessing by the computing device current and historical traffic data for the hybrid-electric vehicle;
accessing by the computing device driver data;
accessing by the computing device point-of-interest data for the current location in which the hybrid-electric vehicle is located; and
generating automatically by the computing device one or more driving routes for the hybrid-electric vehicle based upon the destination, current location, current and historical vehicle data, current and historical traffic data, driver data, and point-of-interest data.

2. The method of claim 1, further comprising:
accessing by the computing device route preferences of a driver of the hybrid-electric vehicle, wherein generating automatically by the computing device one or more driving routes for the hybrid-electric vehicle further comprises generating two or more driving routes based at least in-part on the one or more route preferences.

3. The method of claim 2, further comprising requesting the hybrid-electric vehicle display the two or more driving routes to the driver of the hybrid-electric vehicle for selection by the driver.

4. The method of claim 2, wherein when the driver of the hybrid-electric vehicle selects a preferred route of the generated two or more driving routes, the computing device requests an engine scheduler for the hybrid-electric vehicle associated with the preferred route.

5. The method of claim 2, wherein the route preferences include selectively one or more of the following: time optimization, cost optimization, and distance optimization.

6. The method of claim 3, wherein the displayed two or more driving routes also include display of an engine usage strategy for the hybrid-electric vehicle for each of the two or more driving routes.

7. The method of claim 1, wherein current and historical vehicle data includes selectively one or more of the following: vehicle speed, battery consumption rate, fuel tank capacity, battery capacity, and battery charging time.

8. The method of claim 1, wherein current and historical traffic data includes selectively one or more of the following: road conditions, traffic statutes, regulation areas, and weather information.

9. The method of claim 1, wherein driver data includes selectively one or more of the following: driver behavior data, special driver requirements, and noise level.

10. The method of claim 1, wherein point-of-interest data includes selectively one of the following: gasoline station location data, charging station location data, charging station type information, fuel price, charging prices, charging station power information, and charging station interface information.

11. The method of claim 1, further comprising collecting real-time information, and using the real-time information to determine whether to update the one or more driving routes and, if a determination is made that the one or more driving routes need to be updated, updating the one or more driving routes.

12. A computer system to automatically provide navigation for a hybrid-electric vehicle to best take advantage of the dual-powering capabilities of the hybrid-electric vehicle, the computer system comprising:
one or more computer processors;
one or more computer-readable storage media;
program instructions stored on the computer-readable storage media for execution by at least one of the one or more processors, the program instructions comprising:
program instructions to receive a destination for a hybrid-electric vehicle to navigate the hybrid-electric vehicle to;
program instructions to access a current location of the hybrid-electric vehicle;
program instructions to access current and historical vehicle data for the hybrid-electric vehicle;
program instructions to access current and historical traffic data for the hybrid-electric vehicle;
program instructions to access driver data;
program instructions to access point-of-interest data for the current location in which the hybrid-electric vehicle is located; and
program instructions to automatically generate one or more driving routes for the hybrid-electric vehicle based upon the destination, current location, current and historical vehicle data, current and historical traffic data, driver data, and point-of-interest data.

13. The computer system of claim 12, further comprising program instructions to request the hybrid-electric vehicle display the two or more driving routes to the driver of the hybrid-electric vehicle for selection by the driver.

14. The computer system of claim 13, further comprising program instructions to access route preferences of a driver of the hybrid-electric vehicle, wherein the program instructions to automatically generate one or more driving routes for the hybrid-electric vehicle further comprise program instructions to generate two or more driving routes based at least in-part on the one or more route preferences.

15. The computer system of claim 13, wherein when the driver of the hybrid-electric vehicle selects a preferred route of the generated two or more driving routes, program instructions request an engine scheduler for the hybrid-electric vehicle associated with the preferred route.

16. The computer system of claim 14, wherein route preferences include selectively one or more of the following: time optimization, cost optimization, and distance optimization.

17. A computer program product to automatically provide navigation for a hybrid-electric vehicle to take best advantage of dual-powering capabilities of the hybrid-electric vehicle, the computer program product comprising:
one or more non-transitory computer-readable storage media and program instructions stored on the one or more non-transitory computer-readable storage media capable of performing a method, the method comprising:
receiving by a computing device a destination for a hybrid-electric vehicle to navigate the hybrid-electric vehicle to;
accessing by a computing device a current location of the hybrid-electric vehicle;
accessing by the computing device current and historical vehicle data for the hybrid-electric vehicle;
accessing by the computing device current and historical traffic data for the hybrid-electric vehicle;
accessing by the computing device driver data;
accessing by the computing device point-of-interest data for the current location in which the hybrid-electric vehicle is located; and
generating automatically by the computing device one or more driving routes for the hybrid-electric vehicle based upon the destination, current location, current and historical vehicle data, current and historical traffic data, driver data, and point-of-interest data.

18. The computer program product of claim 17, further comprising accessing by the computing device route preferences of a driver of the hybrid-electric vehicle, wherein generating automatically by the computing device one or more driving routes for the hybrid-electric vehicle further comprises generating two or more driving routes based at least in-part on the one or more route preferences.

19. The computer program product of claim 18, further comprising requesting the hybrid-electric vehicle display the two or more driving routes to the driver of the hybrid-electric vehicle for selection by the driver.

20. The computer program product of claim 19, wherein when the driver selects a preferred route of the two or more genertate4d driving routes, the computing device requests an engine scheduler for the hybrid-electric vehicle associated with the preferred route.
